(19) United States
(12) Patent Application Publication
(10) Pub. No.: US 2009/0251013 A1
(43) Pub. Date: Oct. 8, 2009

(54) Electric Motor for Rotation and Axial Movement

(75) Inventors: Rolf Vollmer, Gersfeld (DE); Erich Bott, Hollstadt (DE); Matthias Braun, Massbach (DE); Holger Schunk, Lendershausen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, Munchen (DE)

(21) Appl. No.: 11/721,777

(22) PCT Filed: Dec. 13, 2005
(86) PCT No.: PCT/EP2005/056712

§ 371 Date: Jun. 14, 2007

(30) Foreign Application Priority Data
Dec. 15, 2004 (DE) 10 2004 060 351.0

(51) Int. Cl. H02K 41/03; H02K 5/167; H02K 7/09

(52) U.S. Cl. 310/12.14; 310/90; 310/90.5

(57) ABSTRACT

The invention relates to a combination drive with a short axial length and a high magnetic capacity. According to the invention, an electric motor comprises a rotational drive device with an outer rotor (AR), and a linear drive device with an outer rotor (AT) or an inner rotor with bearings in the active part. The outer rotor (AR,AT) can be mounted by means of hydrostatic bearings (L1,L2), indirectly by means of a shaft (W), on the stators (SR,ST) of the two drives. Said bearings (L1,L2) are axially arranged inside the outer rotors (AR, AT), presenting a short structural form of the combination drive. Furthermore, the bearings are not located in the magnetic action interstice of the drives, so that they do not influence the capacity of the machine.

The present invention relates to an electric motor having a rotary drive device including a rotor, possibly an internal rotor, and a linear drive device including an external rotor. Such electric motors are also referred to as combination motors.

The mounting for combination motors needs to be suitable both for the rotary movement and for the translatory movement or linear movement in the axial direction. Preferably, sliding bearings can be used here. For this purpose, the sliding bearings need to be arranged at bearing points which are both smooth and cylindrical. It is particularly problematic if short physical shapes of the drives are required.

Until now, constructions have been known in which the bearings are arranged as an axial extension of the active parts. However, this also increases the physical space required for the combination drive. Such a combination drive is known from the document U.S. Pat. No. 4,099,106. Furthermore, the documents DE 101 63 626 A1, U.S. Pat. No. 6,570,275 B2 and U.S. Pat. No. 6,137,195 A describe combination drives in which the linear drive component and the rotary drive component are arranged radially one inside the other.

The object of the present invention now consists in proposing a combination drive with a short physical shape and a high magnetic capacity.

According to the invention, this object is achieved by an electric motor having a rotary drive device including a rotor and a linear drive device including an external rotor, the rotor of the rotary drive device also being in the form of an external rotor.

Furthermore, the invention provides for an electric motor having a rotary drive device including an internal rotor and a linear drive device including an external rotor, a bearing being arranged in the magnetic action interstice of the rotary drive device.

Advantageously, the rotor or a rotatable shaft can therefore be mounted within the external rotor or on the internal rotor, with the result that it is possible to save physical space axially.

The internal or external rotor of the rotary drive device and the external rotor of the translatory or linear drive device can each bear permanent magnets on the inner side. Permanent-magnet synchronous motors having a short physical shape can therefore be realized.

In a specific embodiment, the two external rotors can be connected coaxially to one another and to an axially running shaft such that they are fixed against rotation. Possibly, the two external rotors are integrally connected to one another, with the result that the installation complexity involved when screwing two bell-type rotors to one another can be avoided.

In one development, the rotary drive device and the linear drive device each have an annular stator, and the two stators are connected to one another by a housing of the electric motor and are supported in each case by a bearing on the shaft or the internal rotor. In this way, an encapsulated combination drive can be realized.

The external rotor can, under certain circumstances, be supported on a housing of the electric motor via one or more bearings. This mounting can, if necessary, take place in addition to the stators including the housing being mounted on the shaft.

Preferably, at least one of the bearings has a hydrostatic design. Such a bearing is subject to little wear and has a low frictional resistance.

Likewise, at least one of the bearings may have a magnetic design, which likewise has the advantage of a low frictional resistance. As an alternative to these bearings, however, simple sliding bearings with a lubricant film and roller bearings are also conceivable.

The present invention will be explained in more detail with reference to the attached drawings, in which:

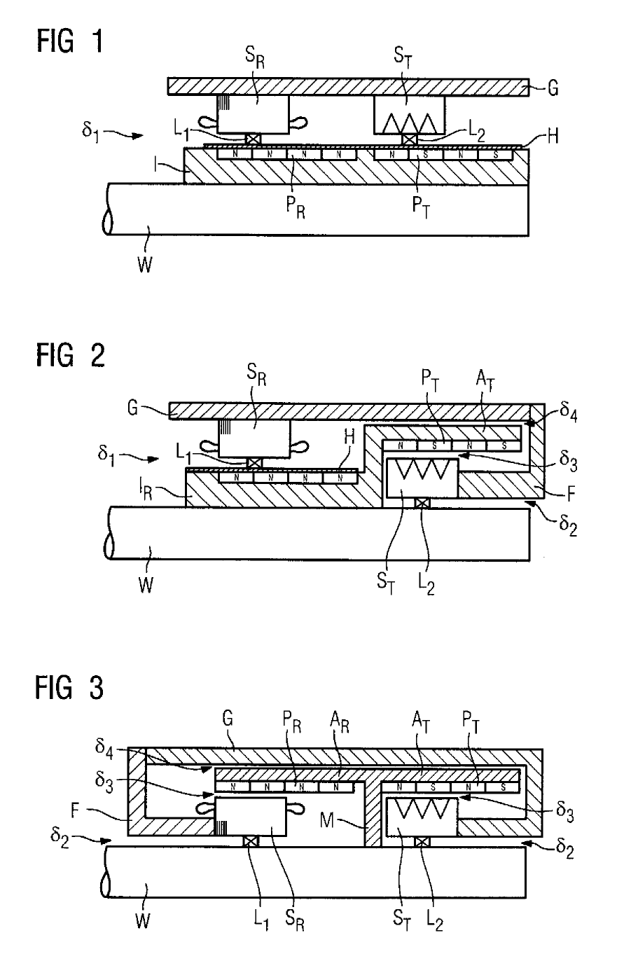

FIG. 1 shows a combination drive having an internal rotor for the rotary and the translatory drive;

FIG. 2 shows a combination drive having an internal rotor for the rotary drive and an external rotor for the translatory drive; and

FIG. 3 shows a combination drive according to the invention having external rotors for the rotary drive and translatory drive.

The exemplary embodiments described in more detail below represent preferred embodiments of the present invention. Firstly, however, a design which has not been claimed is illustrated in FIG. 1 for the purpose of improving the understanding of the invention.

As shown in FIG. 1, the rotary drive and the linear drive are provided with an internal rotor. In order to save on axial physical space, the bearings of the internal rotor are integrated in the magnetic air gap. Specifically, a shaft W bears an internal rotor I, which is provided with permanent magnets P_{R} for the rotary drive and permanent magnets P_{T} for the linear or translatory drive. The permanent magnets P_{R} and P_{T} are surrounded by a sleeve H, which at the same time acts as a bearing sleeve. It is generally manufactured from stainless steel and bears the bearings L₁ and L₂ in the magnetic action air gap δ₁. On the outside, the bearings L₁ and L₂ are supported on the stator S_{R} of the rotary drive and the stator S_{T} of the translatory drive. These are in turn surrounded on the outside by a housing G.

One advantage of this construction is the small axial physical length. However, one disadvantage is the mounting in the active part of the drives, which requires a minimum gap width δ₁. In addition, the bearings L₁ and L₂ can be seen to be magnetically negative in the action air gap. Furthermore, the bearings L₁ and L₂ become hot at high rotation speeds, which may lead to damage to the permanent magnets P_{R} and P_{T}.

When using hydrostatic bearings, both the stator inner faces and the rotor surfaces need to be produced such that they are sufficiently smooth, which is in general very complex. For a sliding bearing arrangement, at least one of these faces needs to be smooth.

A construction of a combination drive which is improved in accordance with the invention is reproduced in FIG. 2. In this case, the rotary drive, as in the example shown in FIG. 1, has an internal rotor I_{R}, but the translatory drive has an external rotor A_{T}. The external rotor A_{T} has a bell-shaped design, for which reason it is also referred to as a bell-type rotor. It may be integrally connected to the internal rotor I_{R}. The permanent magnets P_{T} are arranged on the inner face of the external rotor A_{T}. The housing G bears the stator S_{R} of the rotary drive and surrounds the external rotor A_{T} of the translatory drive. The stator S_{T} of the translatory drive is connected to the housing G such that it is fixed against rotation via a flange F.

There is a gap δ₂ between the shaft W and the stator S_{T}, and this gap is used for the bearing L₂. An air gap δ₃ between the stator S_{T} and the permanent magnets P_{T} of the translatory drive may be selected to be very small, since a bearing does not need to be provided there. A further gap δ₄ between the external rotor A_{T} and the housing G can likewise be used for an additional bearing arrangement. In the example shown in FIG. 2, a bearing has been dispensed with here.

FIG. 3 shows, corresponding to an alternative embodiment, an encapsulated combination drive having the two external rotors A_{R} and A_{T} for the rotary drive and the translatory drive. The cross section of the external rotor in one half, as illustrated in FIG. 3, therefore has a T structure. The central section M bearing the two external rotors A_{R} and A_{T} is shrunk, pressed or fixed in another way onto the shaft W. The external rotors A_{R} and A_{T} are illustrated as being integral in FIG. 3. Alternatively, two bell-type rotors are screwed to one another at their base, with the result that a common central section M is provided.

In the interior, the two external rotors A_{R} and A_{T} are equipped with corresponding magnet arrangements P_{T}, P_{R}. As is indicated in FIG. 3, in the case of the rotary drive the north and south poles alternate in the circumferential direction. In contrast, in the case of the translatory drive the north and south poles alternate in the axial direction. The respective stators S_{R} and S_{T} are arranged radially within the external rotors A_{R} and A_{T}. The stator S_{T} of the translatory drive is fitted to a housing section of the housing G, which housing section protrudes into the interior of the external rotor A_{T}. Similarly, the stator S_{R} of the rotary drive is fixed to a flange F, which for its part protrudes into the interior of the external rotor A_{R} and is fitted to the housing G. The stators S_{R} and S_{T} are mounted on the shaft W with the aid of hydrostatic bearings L₁, L₂, sliding bearings or the like. A defined gap δ₂ is therefore formed between the shaft and the two stators S_{R} and S_{T}, but also a defined gap δ₃ between the stators S_{R}, S_{T} and the respective permanent magnets P_{R}, P_{T} as well as a defined gap δ₄ between the external rotors A_{R}, A_{T} and the housing G. In the gap δ₄, a large-area or two narrower hydrostatic bearings may be provided in order to guide the external rotor more precisely.

The design of the combination drive corresponding to FIG. 3 has the advantage that three gaps are provided in the radial direction, one being used for the transmission of magnetic forces and it being possible for the other two to be used for mounting purposes. In the two gaps δ₂ and δ₄, which are used for the mounting, surfaces may be produced in a simple manner which are suitable for a sliding bearing arrangement and for sealing purposes. Likewise, the surface in these two gaps δ₂ and δ₄ can easily be designed to be chemically resistant, for example to the pressurized oil of a hydrostatic bearing.

As a result of the fact that the bearings L₁ and L₂ are located within the external rotors, the axial physical length of the combination drive can be restricted to substantially the length of the active parts including the translatory displacement path. Furthermore, no bearings need to be arranged between the active parts, with the result that the magnetic capacity is correspondingly high.

1.-13. (canceled)

14. An electric motor, comprising:
a rotary drive device including an internal rotor;
a linear drive device including an external rotor; and
a first bearing arranged in a magnetic action interstice of the rotary drive device.

15. The electric motor of claim 14, further comprising first permanent magnets arranged on an inner side of the external rotor of the linear drive device, and second permanent magnets arranged on an outer side of the internal rotor of the rotary drive device.

16. The electric motor of claim 14, wherein the rotary drive device has an annular stator which is supported by the first bearing on the internal rotor, and the linear drive device has an annular stator, further comprising a housing for connecting the stator of the rotary drive device and the stator of the linear drive device to one another, and a second bearing for supporting the stator of the linear drive device on a shaft.

17. The electric motor of claim 14, wherein the external rotor is supported on a housing by at least one second bearing.

18. The electric motor of claim 16, wherein at least one of the first and second bearings is a hydrostatic bearing.

19. The electric motor of claim 16, wherein at least one of the first and second bearings is a magnetic bearing.

20. The electric motor of claim 17, wherein at least one of the first and second bearings is a hydrostatic bearing.

21. The electric motor of claim 17, wherein at least one of the first and second bearings is a magnetic bearing.

22. An electric motor, comprising:
a rotary drive device including an external rotor and an annular stator;
a linear drive device including an external rotor and an annular stator, wherein the external rotor of the rotary drive device and the external rotor of the linear drive device are connected coaxially to one another;
an axial shaft to which the external rotor of the rotary drive device and the external rotor of the linear drive device are connected in fixed rotative engagement;
a housing for connecting the stator of the rotary drive device and the stator of the linear drive device to one another;
a first bearing for supporting the stator of the rotary drive device on the shaft; and
a second bearing for supporting the stator of the linear drive device on the shaft.

23. The electric motor of claim 22, further comprising first permanent magnets arranged on an inner side of the external rotor of the linear drive device, and second permanent magnets arranged on an inner side of the external rotor of the rotary drive device.

24. The electric motor of claim 22, further comprising a housing for supporting the external rotor of the linear drive device and the external rotor of the of the rotary drive device via at least one third bearing.

25. The electric motor of claim 22, wherein at least one of the first and second bearings is a hydrostatic bearing.

26. The electric motor of claim 22, wherein at least one of the first and second bearings is a magnetic bearing.

27. The electric motor of claim 22, wherein the external rotor of the linear drive device and the external rotor of the of the rotary drive device define a single-piece construction.
